(19) United States
(12) Patent Application Publication
(10) Pub. No.: US 2026/0249327 A1
(43) Pub. Date: Aug. 27, 2026

(54) Kloser Corrosion Cleaner

(71) Applicant: Jeffery Kloser, Adrian, MO (US)

(72) Inventor: Jeffery Kloser, Adrian, MO (US)

(21) Appl. No.: 19/062,309

(22) Filed: Feb. 27, 2025

(51) Int. Cl. B08B 1/36; B08B 1/16; B60H 1/00

(52) U.S. Cl. CPC B08B 1/36; B08B 1/165; B60H 1/00585

(57) ABSTRACT

A corrosion cleaning tool for automotive air conditioning line connections, particularly at the rear mounting point where a steel stud engages an aluminum housing. The device includes a cylindrical cleaning head with abrasive elements arranged to encircle the connection, removing corrosion, oxidation, and debris through rotational motion. The cleaning head may be driven manually or by a powered tool. The design enables thorough cleaning without disassembly of the line, improving connection integrity, and reducing service time.

### CROSS-REFERENCE TO RELATED APPLICATIONS (IF ANY)

Not applicable.

### STATEMENT REGARDING FEDERALLY SPONSORED RESEARCH OR DEVELOPMENT (IF ANY)

Not applicable.

### BACKGROUND OF THE INVENTION

### Field of the Invention

The present invention relates generally to the automobile service industry, and more specifically to auto technicians.

### Description of the Related Art

Rear air conditioning lines are mounted to the evaporator; the line has a hole that holds the expansion valve and the stud on the rear mount (which corrodes due to the steel stud in an aluminum housing. Currently there is not a solution to clean the lines, they have to be replaced due to being damaged if tried to clean.

### SUMMARY OF THE INVENTION

The invention provides a corrosion cleaning tool and a method that is specifically designed for the rear mounted A/C lines in automobiles. The Kloser Corrosion Cleaner enables technicians to quickly and efficiently remove corrosion buildup caused from the steel stud and aluminum housing without dismantling the entire system. The tool is compact, insertable, and provides quick cleaning of the corrosion.

### BRIEF DESCRIPTION OF THE DRAWINGS

FIG. 1: is a metal tube 4.5 inches long, and ⅜ inches in circumference (14) with 7 notches cut into one end, aka cutting head (16), there is a bolt on the other end (10), and a pin through the side (12).

FIG. 2: is a close up of the notches/cutting head (16) and showing the metal tube (14).

FIG. 3: is a diagram of the bolt (10) and pin (12) in the side of the metal tube.

### DETAILED DESCRIPTION OF THE INVENTION

Referring now to FIG. 1, the bolt (10) and pin (12) allow for the use of an impact or driver to rotate the cutting head (16). The bolt and pin allow for the use of an impact or driver to rotate the cutting head (16), or it can be used manually.

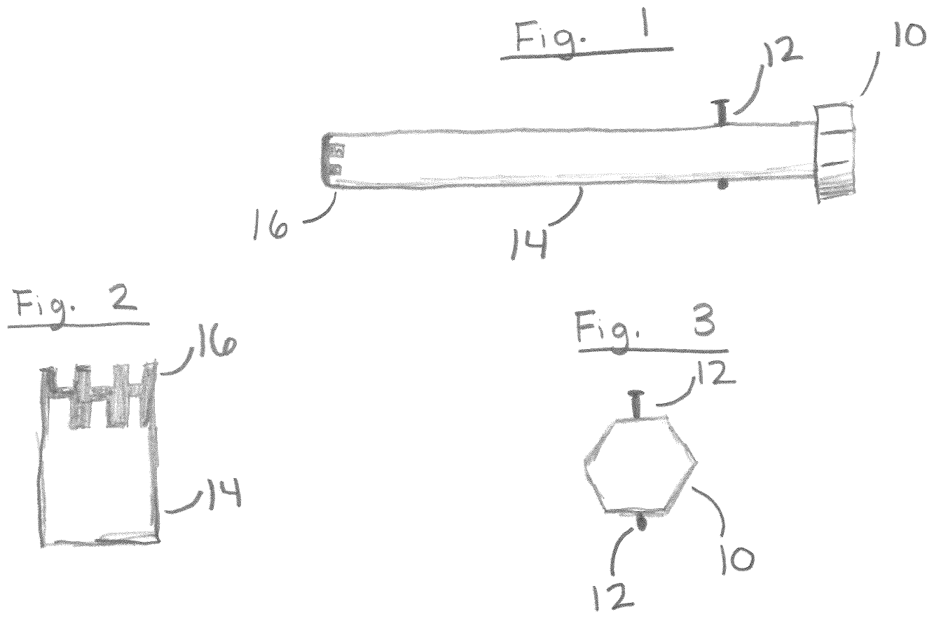

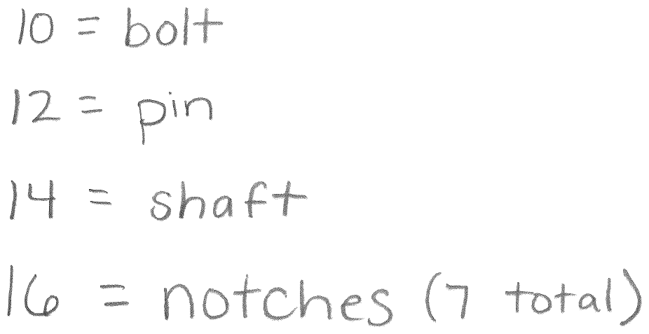

FIG. 2, Close up of the notches/cutting head (16) Each reference character used in the drawings (as required by 37 CFR 1.74) corresponds to a component or step described herein.

Reference Numeral List (per 37 CFR §1.77(b)(9))

| Reference No. | Component Name |
|---|---|
| 10 | Bolt |
| 12 | Pin |
| 14 | Metal Tube |
| 16 | Notches/Cutting Head |

### ABSTRACT OF THE DISCLOSURE

A tool designed to clean rear air conditioning lines so keep them in place instead of having to replace the lines.

### Incorporation by Reference (If Continuation or Divisional)

Not applicable.

1. Rear air conditioning lines are mounted to the evaporator. The air conditioning line has a hole that holds the expansion valve and stud on the rear mount, which corrodes due to the steel stud in an aluminum housing. The air conditioning line needs to be replaced when cleaning out the corrosion due to it being damaged because of the process of cleaning the corrosion. With this tool, the corrosion can be cleaned, leaving the air conditioning line intact and no longer needing to be replaced. I have made a prototype and used it successfully on several occasions.
